(19) United States
(12) Patent Application Publication
(10) Pub. No.: US 2011/0225327 A1
(43) Pub. Date: Sep. 15, 2011

(54) SYSTEMS AND METHODS FOR CONTROLLING AN ELECTRONIC DEVICE

(75) Inventors: JOE TOM, Foster City, CA (US); Sylvain Dubois, Paris (FR)

(73) Assignee: Spansion LLC, Sunnyvale, CA (US)

(21) Appl. No.: 12/723,582

(22) Filed: Mar. 12, 2010

(51) Int. Cl. G06F 13/10

(52) U.S. Cl. 710/58

(57) ABSTRACT

Systems and methods (600) for controlling an electronic device (100) with an active processing module (308) having a first and second input/output interface (502, 504). The methods involve interfacing the active processing module and a computing device using the first input/output interface of the active processing module. Thereafter, the active processing module is programmed using a user interface of the computing device. The method also involves interfacing the active processing module and the electronic device using at least the second input/output interface of the active processing module. Subsequently, the operations of the electronic device are controlled using a processing unit (506) of the active processing module and/or a processing unit (424) of the electronic device.

### BACKGROUND OF THE INVENTION

### Statement of the Technical Field

The invention relates to electronic devices. More particularly, the invention relates to systems and methods for controlling electronic devices such that the portable electronic devices act in customized manners.

### DESCRIPTION OF THE RELATED ART

There are many conventional electronic devices known in the art. Such electronic devices include, but are not limited to, digital cameras, digital camcorders, gaming machines, navigation units and digital picture frames. Each of the conventional electronic devices is designed for a single application. For example, conventional digital cameras are configured to record images as still photographs. In this regard, the conventional digital cameras typically include an imaging device which is controlled by a computer system. The computer system accesses raw image data captured by the imaging device. Thereafter, the computer system processes the raw image data for compressing the same. The compressed image data is then stored in an internal memory of the camera.

### BRIEF DESCRIPTION OF THE DRAWINGS

Embodiments will be described with reference to the following drawing figures, in which like numerals represent like items throughout the figures, and in which:

FIG. 1 is a front view of an exemplary electronic device that is useful for understanding the present invention;

FIG. 2 is a rear view of the exemplary electronic device of FIG. 1 that is useful for understanding the present invention;

FIG. 3 is a side view of the exemplary electronic device of FIGS. 1-2 that is useful for understanding the present invention;

FIG. 4 is a block diagram of an exemplary circuit of the exemplary electronic device of FIGS. 1-3 that is useful for understanding the present invention;

FIG. 5 is a schematic illustration of an exemplary active processing module that is useful for understanding the present invention; and

FIG. 6 is a flow diagram of an exemplary method for controlling operations of an appliance that is useful for understanding the present invention.

### DETAILED DESCRIPTION OF THE PREFERRED EMBODIMENTS

The present invention will now be described with reference to the attached figures, wherein like reference numbers are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The present invention generally concerns systems and methods for controlling an electronic device (e.g., a camera, a camcorder, a navigation unit, a gaming machine and a digital picture frame). The systems generally employ a removable and programmable active processing module configured for enabling an electronic device to act in a customized manner, i.e., perform a primary function using at least one custom operating parameter or perform a secondary function different from its primary function. For example, the active processing module can be programmed to control operations of a digital camera such that it performs one or more secondary functions (e.g., a travel guide function, a navigation function, a gaming function, a learning guide function, an assistant function, an electronic book viewer function, a media player function and/or a wireless connection function).

Notably, the active processing module provides an affordable way to add additional applications to the electronic device without jeopardizing the competitiveness of the selling price position of the electronic device. The active processing module also provides an affordable way to add additional applications to the electronic device without affecting the quality level of the electronic device.

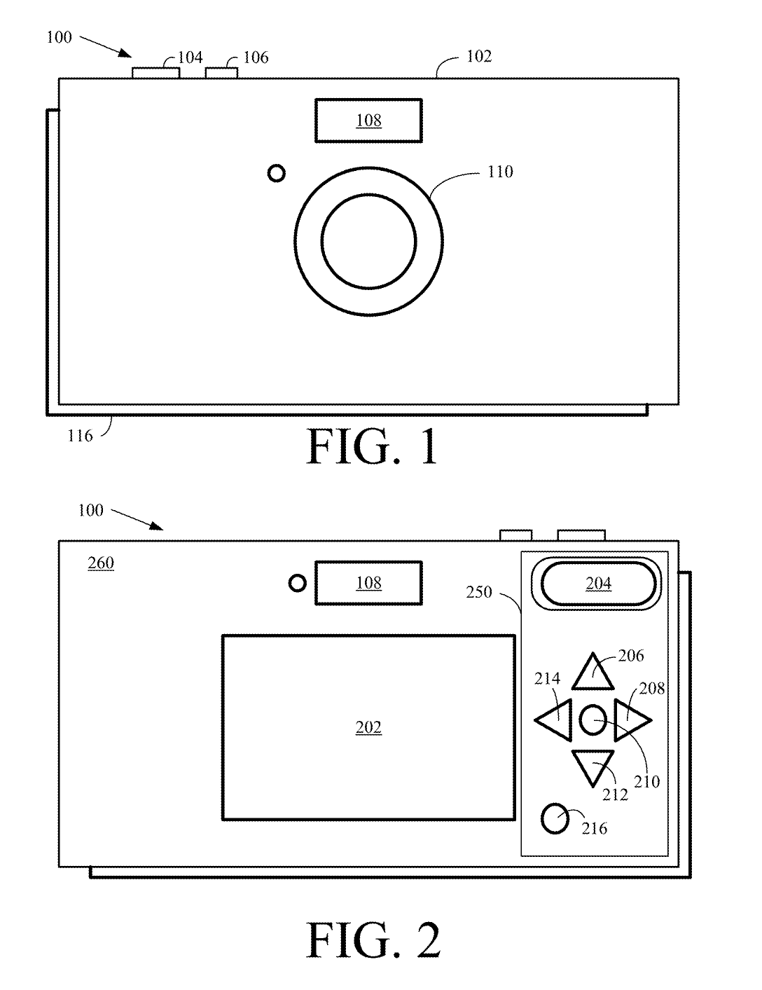

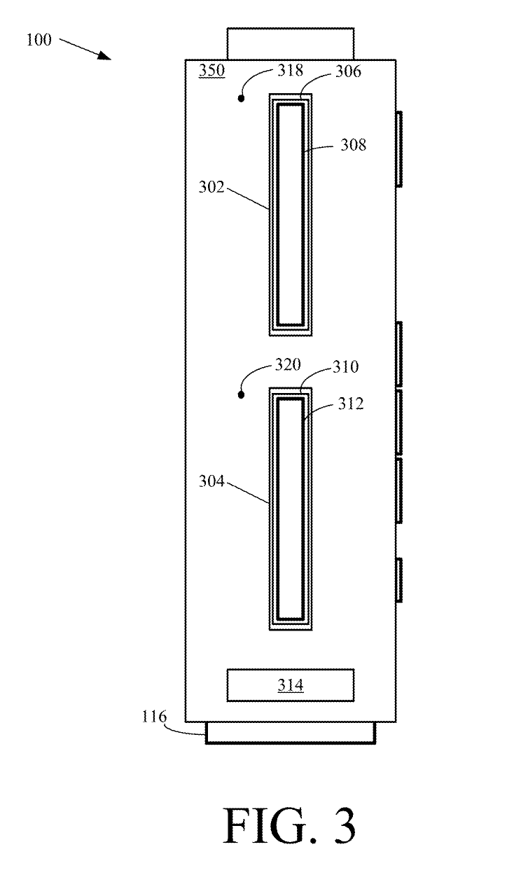

Referring now to FIGS. 1-3, there is provided an exemplary camera 100 that is useful for understanding the present invention. A front view of the camera 100 is provided in FIG. 1. A rear view of the camera 100 is provided in FIG. 2. A side view of the camera 100 is provided in FIG. 3. As noted above, the present invention is not limited to camera applications. The present invention can be used in various other electronic device applications, such as digital camcorder applications, gaming machine applications, navigation unit applications and digital picture frame applications. However, the present invention will be described in relation to camera applications for purposes of simplicity and illustrative convenience.

The camera 100 is generally configured to perform a primary function (i.e., to record images as still photographs) that is intended by a designer and/or a manufacturer thereof. However, the camera 100 is also configured to operate in a customized manner. In this regard, the camera 100 can be customized to perform secondary functions and/or its primary function using customized parameter values. The secondary functions are functions different than the primary functions of the camera 100 that were intended by the designer and/or manufacturer thereof. For example, the camera 100 can be customized to operate as a digital travel guide, a navigation unit, a gaming machine, a digital learning guide, a digital cooking assistant, a digital cooking guide, an electronic book viewer, a digital phone book and/or a personal digital calendar. Embodiments of the present invention are not limited in this regard. For example, if the electronic device is a camcorder or a gaming machine (instead of a camera), then the electronic device can further be customized to operate as a digital media player.

As shown in FIGS. 1-3, the camera 100 comprises an on/off switch 106 and a body 102 generally formed as a rectangular box that can be gripped in the hand of a user using a handgrip 116. A viewfinder 108 is optically coupled to a lens 110, so that the user of the camera 100 who wishes to take a picture can look through the viewfinder 108 to line up a shot. When the user depresses a button 104, a still photograph is captured by the camera 100. The captured still photograph is then processed and stored in a solid state memory device (not shown in FIGS. 1-3) within the camera 100 and/or in a removable memory 312 of the camera 100 (e.g., a flash memory card). A display device 202 is provided for enabling a user to view a recently captured still photograph prior to the storage thereof. The display device 202 also enables a user to view stored still photographs and camera settings. The display device 202 can include, but is not limited to, a Liquid Crystal Display (LCD).

An input device 250 is provided on a rear panel 260 of the camera 100. The input device 250 can include, but is not limited to, buttons 204, 206, 208, 210, 212, 214 and 216. The buttons 204, . . . , 216 are used to signal various logical selections of options and commands based on the content of the display device 202.

A communication interface 314 is provided on a side panel 350 of the camera 100. The communication interface 314 can include, but is not limited to a Universal Serial Bus (USB) interface. The communication interface 314 facilitates the coupling of the camera 100 to a computing device (not shown in FIGS. 1-3). The computing device can include, but is not limited to, a computer workstation, a desktop personal computer system, a laptop personal computer system, or any other general purpose computer processing device. The computing device executes a program that can read the stored still photographs from the solid state memory device (not shown in FIGS. 1-3) within the camera 100. The computing device thereafter displays the still photographs on its display screen. Under software control, the computing device can send the still photographs to a printer, store the still photographs in a memory thereof, and carry out other functions. The other functions can include, but are not limited to, photo editing functions such as cropping functions, rotating functions, exposure functions, red eye removal functions, touchup functions, saturation functions and auto correct functions.

A removable memory interface (not shown in FIGS. 1-3) and a connector 304 is also provided for facilitating the communication of still photograph data to and from a removable memory module 312. In embodiments of the present invention, the connector 304 is recessed in relation to an exposed surface of the side panel 350 of the camera 100. In this scenario, the connector 304 is disposed in an insert space 310 sized and shaped for receiving at least a portion of the removable memory module 312. Embodiments of the present invention are not limited in this regard.

An actuation mechanism 320 is provided for ejecting the removable memory module 312 from the insert space 310. After removing the removable memory module 312 from the camera 100, the user can connect the removable memory module 312 to the computing device (not shown in FIGS. 1-3) for printing, viewing and/or editing still photographs stored on the removable memory module 312.

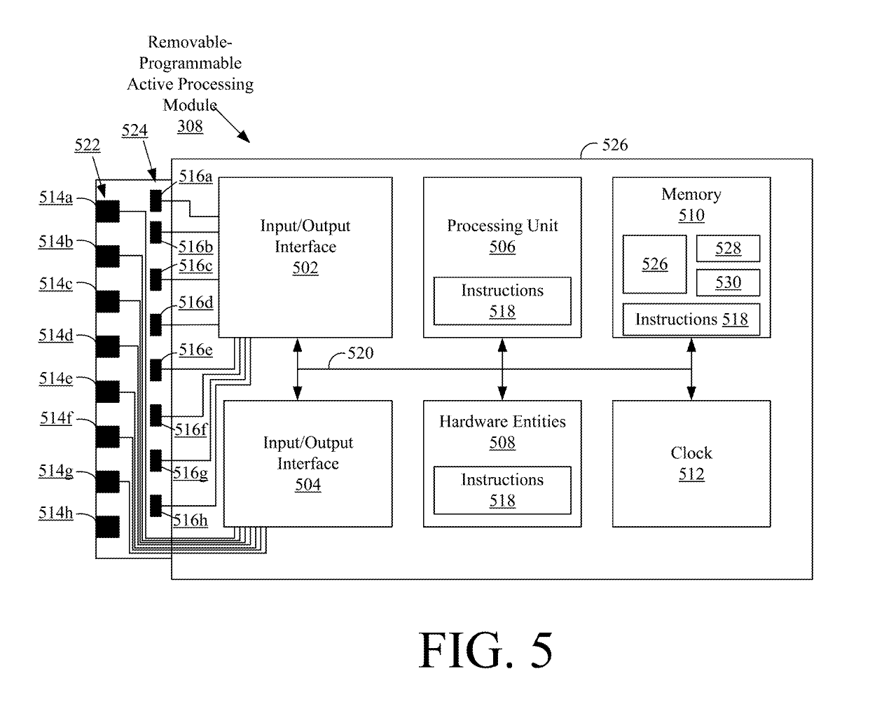

As noted above, the camera 100 is configured to operate in a customized manner. The customizability of the camera 100 is facilitated by a removable-programmable active processing module 308. The active processing module 308 can be a plug-and-play card. An exemplary embodiment of the active processing module 308 will be described in detail below in relation to FIG. 5. Still, it should be noted that the active processing module 308 includes hardware and/or software configured for enabling the customization of operations of the camera 100.

As shown in FIG. 3, a connector 302 is provided for facilitating the coupling of the active processing module 308 to the camera 100. For example, the connector 302 can include an edge connector socket sized and shaped to receive an edge connector of the active processing module 308. In this scenario, the edge connector socket can be recessed in relation to an exposed surface of the side panel 350 of the camera 100. More particularly, the edge connector socket can be disposed in an insert space 306 sized and shaped for receiving at least a portion of the active processing module 308. An actuation mechanism 318 can be provided for ejecting the active processing module 308 from the insert space 306. Embodiments of the present invention are not limited in this regard.

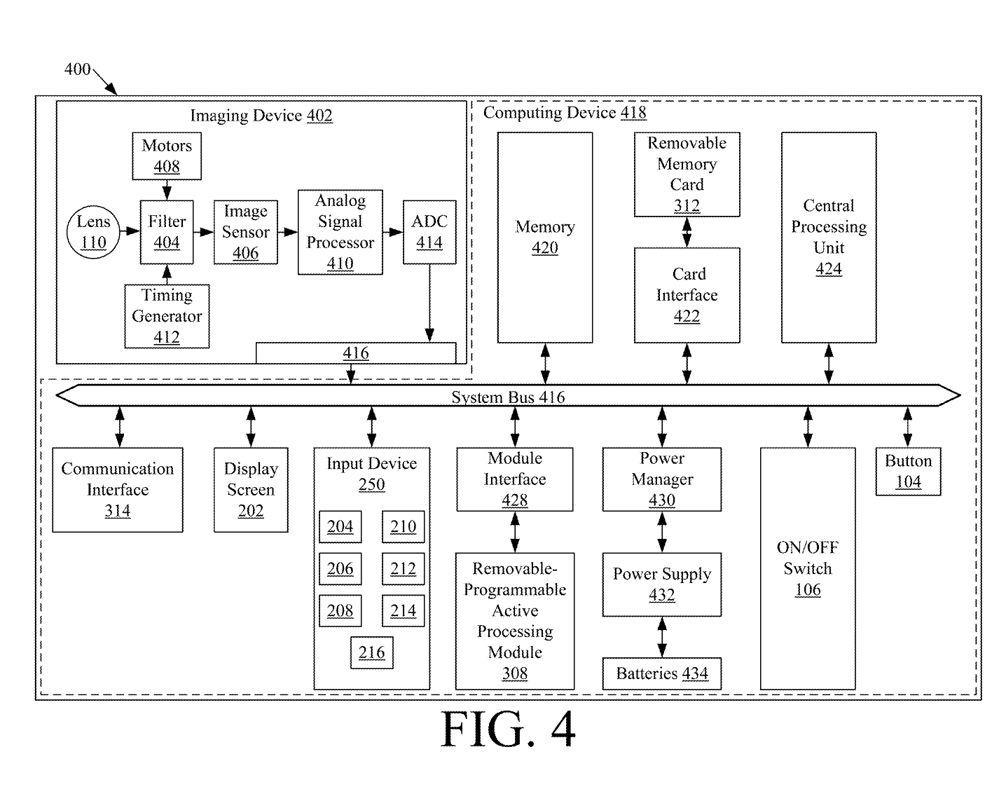

A block diagram of an exemplary circuit 400 of the camera 100 is provided in FIG. 4. The circuit 400 may include more or less components than those shown in FIG. 4. However, the components shown are sufficient to disclose an illustrative embodiment implementing the present invention.

As shown in FIG. 4, the circuit 400 includes an imaging device 402 and a computing device 418. The imaging device 402 is electrically coupled to the computing device 418 via a system bus 416. In response to the depression of the button 104 by a user of the camera 100, the computing device 418 commands the imaging device 402 to capture raw image data representing an object (not shown). The raw image data is communicated from the imaging device 402 to the computing device 418 for processing and storage thereat. Status and control information can also be communicated between the imaging device 402 and the computing device 418 via the system bus 416.

The imaging device 402 can include, but is not limited to, the lens 110, a filter 404, an image sensor 406, motors 408, an analog signal processor 410, a timing generator 412, an Analog to Digital Converter (ADC) 414 and an interface 418. Each of these components 110, 404, . . . , 418 is known to persons having ordinary skill in the art, and thus will not be described herein.

The computing device 418 includes the removable memory module 312, the communication interface 314, the active processing module 308, the display screen 202 and the input device 250. As noted above, the camera 100 can be coupled to an external computing device through the communication interface 314. The communication interface 314 can send information (e.g., still image information) between the camera 100 and external computing device (not shown in FIG. 4). The computing device 418 also includes a Central Processing Unit (CPU) 424 and a memory 420 connected to and accessible by other portions of the camera 100 through system bus 416. The circuit 300 further includes a module interfaces 422, 428, a power manager 430, a power supply 432 and batteries 434.

The CPU 424 performs actions involving access to and use of memory 420, 312. Memory 420 includes volatile and/or non-volatile memory. For example, the memory 420 can include, but is not limited to, Random Access Memory (RAM), Dynamic Random Access Memory (DRAM), Static Random Access Memory (SRAM), Read Only Memory (ROM), flash memory, a disk driver and/or other forms of program bulk-storage. One or more device-control applications are stored in memory 420 and executed by the CPU 424. The device-control applications are generally operative to control operations of the camera 100 such that it performs its primary function using original operating parameter values (e.g., captures still images of objects).

In this regard, the CPU 424 performs actions for controlling the operations of the camera 100 in accordance with a user input. The user input is facilitated by the on/off switch 106, the button 104, the display screen 202 and the input device 250. The input device 250 includes, but is not limited to, buttons 204, . . . , 216. The buttons 204, . . . , 216 are configured to remain in a rest position until pressed, whereupon the buttons are placed in their actuated positions until the pressing force is removed. Pressing a button 204, . . . , 216 causes an electrical signal to be communicated to the CPU 424. In response to the reception of the electrical signal, the CPU 424 controls the operations of the camera 100.

The operations of the camera 100 can also be controlled by the active processing module 308. In this regard, the circuit 400 includes a module interface 428. When the active processing module 308 is inserted into the camera 100, the CPU 424 can be inhibited from controlling operations of the camera 100. In this scenario, the active processing module 308 acts as a new master of the camera 100 in addition to the CPU 424. Embodiments of the present invention are not limited in this regard. For example, the operations of the camera 100 can be controlled by the active processing module 308 working in conjunction with the CPU 424.

Notably, the active processing module 308 can be programmed by a user using a computer workstation, a desktop personal computer system, a laptop personal computer system, or any other general purpose computer processing device. This programming can generally involve defining customized values for operating parameters of the camera 100. For example, a user can set a shutter or exposure time to a desired duration for a particular application. The user can also develop and/or store a device-control application on the active processing module 308. In this scenario, the device-control application can be operative to cause the camera 100 to perform a secondary function other than its intended primary function. The device-control application can also be operative to cause the camera 100 to perform its primary function using customized values for one or more operating parameters.

A detailed block diagram of an exemplary embodiment of the active processing module 308 is provided in FIG. 5. The active processing module 308 may include more or less components than those shown in FIG. 5. However, the components shown are sufficient to disclose an illustrative embodiment implementing the present invention.

The hardware architecture of FIG. 5 represents one embodiment of a representative active processing module 308 configured to execute various types of software programs and applications. For example, the active processing module 308 can execute an operating system, a compiler, a file system and software development applications 526 for facilitating the development and installation of device-control applications 528. The active processing module 308 is also configured to execute device-control applications 528 for controlling an operation of an electronic device.

According to embodiments of the present invention, the active processing module 308 is designed so as to be useful in low power applications and/or high performance application. The active processing module 308 is also designed so as to be useful in space sensitive applications. In this regard, it should be understood that the active processing module 308 is sized and shaped in accordance with a particular application. More particularly, the active processing module 308 can have dimensions selected based on die size, thermal dissipation and the packaging technology employed for packaging the electronic components thereof. For example, the active processing module 308 can have the following dimensions: 43 mm by 36 mm; 32 mm by 24 mm; 21 mm by 20 mm; or 11 mm by 15 mm. Embodiments of the present invention are not limited in this regard.

As shown in FIG. 5, the active processing module 308 generally includes a substrate, for example a Printed Circuit Board (PCB) 526, with a plurality of electronic components disposed thereon. The electronic components include connectors 522, 524 (e.g., edge connectors), a processing unit 506 and a system bus 520. The electronic components also include a memory 510 connected to and accessible by other portions of active processing module 308 through system bus 520. The electronic components further include Input/Output (I/O) interfaces 402, 404, a clock 412 and hardware entities 408. At least some of the hardware entities 508 perform actions involving access to and use of memory 510. The memory 510 can include volatile and/or non-volatile memory. For example, the memory 510 can include, but is not limited to, Random Access Memory (RAM), Dynamic Random Access Memory (DRAM), Static Random Access Memory (SRAM), Read Only Memory (ROM), flash memory, a disk driver and/or other forms of program bulk-storage.

The I/O interface 504 is communicatively coupled to the connector 522. The connector 522 comprises a plurality of pads 514a, 514b, 514c, 514d, 514e, 514f, 514g, 514h formed of a conductive material. The pads 514a, . . . , 514h are electrically isolated from each other. The pads 514a, . . . , 514h provide electrical contacts for electrically connecting the active processing module 308 to an external device (e.g., the camera 100 shown in FIG. 1). The pads 514a, . . . , 514h may be recessed or raised relative to a surface of the PCB 526. One or more of the pads 514a, . . . , 514h can be provided for electrically connecting a power source to the active processing module 308.

The I/O interface 504 and connector 522 collectively enable the customization of operations for consumer electronic devices (e.g., the camera 100 of FIG. 1). For example, the connector 522 is sized and shaped to mate with an edge socket connector of a general purpose computing device (not shown in FIG. 5). Notably, when the active processing module 308 is coupled to the general purpose computing device, the I/O interface 504 configures itself to match with the general purpose computing device in terms of electrical interface and protocol standard. In this regard, the I/O interface 504 can operate as a Secure Digital Input Output (SDIO) interface, a Universal Asynchronous Receiver/Transmitter (UART) interface, an I2C interface, a USB interface and/or Radio Frequency (RF) interface.

According to embodiments of the present invention, the I/O interface 504 will automatically configure itself to communicatively couple the active processing module to the external device by performing the following operations. First, the I/O interface 504 is automatically powered-on when the active processing module 308 is inserted into the edge socket connector of a computing device. When powered on, the processing unit 506 of the removable programmable active processing module 308 executes a boot code from the local memory storage unit 510. The boot code comprehends the required self-configuration of the I/O interface. Thereafter, boot code enables communications between the active processing module 308 and the external computing device. Embodiments of the present invention are not limited in this regard.

The I/O interface 504 enables communication of information from the external device (not shown in FIG. 5) to the active processing module 308, and vice versa. Consequently, a user can access the memory 510 of the active processing module 308 via the external device (not shown in FIG. 5). In this scenario, the user can interact with and control software applications of the active processing module 308. More particularly, the user can develop and install customized device-control applications 528 for causing a consumer electronic device to perform secondary functions other than its intended primary function. The user can also modify or define value for operating parameters of the electronic device using the external device (not shown in FIG. 5). In this regard, the external device (not shown in FIG. 5) can read data from the memory 510 and write data to the memory 510 for storage therein.

The operating parameters that a user can customize depends on the type of device the active processing module 308 is intended to control. For example, if the electronic device is a camera 100, then the operating parameters can include, but are not limited to, a shutter or exposure time parameter, a gain or contrast parameter, an offset or brightness parameter, an auto exposure parameter, a sharpness parameter, a gamma parameter, a saturation parameter, a hue parameter and/or a white balance parameter. Embodiments of the present invention are not limited in this regard. For example, if the electronic device is a camcorder, then the operating parameters can also include, but are not limited to, a zoom parameter, a start parameter, a stop parameter, a play parameter, a rewind parameter, a forward parameter, a record parameter, a time parameter, a volume parameter, a mute parameter, an audio output parameter, a video output parameter and display parameters. In certain scenarios, the operating parameters can further include motion detection parameters, power consumption parameters, energy reduction parameters, renewable energy management parameters, voice command parameters and various video game parameters.

The I/O interface 502 is communicatively coupled to the connector 524. The connector 524 comprises a plurality of pads 516a, 516b, 516c, 516d, 516e, 516f, 516g, 516h formed of a conductive material. The pads 516a, . . . , 516h are electrically isolated from each other. The pads 516a, . . . , 516h provide electrical contacts for electrically connecting the active processing module 308 to an external device (not shown in FIG. 5). The pads 516a, . . . , 516h may be recessed or raised relative to a surface of the PCB 526. One or more of the pads 516a, . . . , 516h can be provided for electrically connecting a power source to the active processing module 308.

The I/O interface 502 and connector 524 facilitate the control of electronic devices (e.g., the camera 100 of FIG. 1) by the processing unit 506. In this regard, the connector 524 is sized and shaped to mate with an edge socket connector (e.g., the connector 302 of FIG. 3) of the electronic device. The I/O interface 502 enables communication of information from the electronic device to the processing unit 506, and vice versa. The information can include, but is not limited to, commands, operating parameter values, display information, audio information and status information. The I/O interface 502 can be operative as an Ethernet interface, a USB interface, a Serial Advanced Technology Attachment (ATA) interface, a Controller Area Network (CAN) interface, a Joint Test Action Group (JTAG) interface, an Analog to Digital (A/D) interface, a Digital to Analog (D/A) interface and/or an RF interface. The I/O interface 502 is configurable such that it can operate as one or more of the above listed types of interfaces based on power consumption and marketing requirements of the active processing module 308.

According to embodiments of the present invention, the I/O interface 502 will automatically configure itself to communicatively couple the active processing module to the electronic device by performing the following operations. First, the I/O interface 502 is automatically powered-on when the active processing module 308 is inserted into the edge socket connector of the electronic device. When powered on, the processing unit 506 of the removable programmable active processing module 308 executes a boot code from the local memory storage unit 510. The boot code comprehends the required self-configuration of the I/O interface. Thereafter, the boot code enables communications between the active processing module 308 and the external electronic device. After the communications have been enabled, the active processing card 308 can takes direct control of the system bus 416 of the electronic device or negotiate with the CPU 424 of the electronic device for control over the system bus 424. Embodiments of the present invention are not limited in this regard.

Although each of the connectors 522, 524 are shown in FIG. 5 to include eight (8) electrical contacts 514a, . . . , 514h, 516a, . . . , 516h, embodiments of the present invention are not limited in this regard. Each connector 522, 524 can include any number of electrical contacts.

Although each of the I/O interfaces 502, 504 has been described to enable the programming of the active processing module 308 or to enable the control of electronic devices, embodiments of the present invention are not limited in this regard. For example, either of the I/O interfaces 502, 504 can be configured to interface with a computing device and/or an electronic device.

Hardware entities 508 may include Field Programmable Gate Arrays (FPGAs), microprocessors, Application Specific Integrated Circuits (ASICs) and other hardware. Hardware entities 508 are generally configured for facilitating the development of device-control applications 528 by a consumer or manufacturer of the active processing module 308. In this regard, it should be understood that the hardware entities 508 can access and run software development applications 530 stored in the memory 510 of the active processing module 308. The software development applications 530 are generally operative to perform software development operations and software installation operations. Software development and installation operations are well known to those having ordinary skill in the art, and therefore will not be described herein. The software development applications 530 can include, but are not limited to, a Real Time Operating System (RTOS), a C compiler, a C++ complier, a Java compiler, a debugger, an emulator, a file system, drivers, FPGA tools, an Integrated Development Environment (IDE) and exemplary codes for controlling a household appliance or other consumer electronic device.

The hardware entities 508 are also generally configured to facilitate user-software interactions for defining and/or modifying values for operating parameters of a consumer electronic device (e.g., the camera 100 of FIG. 1). In this regard, it should be understood that the hardware entities 508 can access and run parameter setting applications 530 stored in memory 510 of the active processing module 308. The parameter setting applications 528 are generally operative to perform parameter setting operations. The parameter setting operations can involve, but are not limited to, prompting a user to input a value for a particular operating parameter and storing the inputted value in memory 510.

As shown in FIG. 5, the hardware entities 508 can include a computer-readable storage medium on which is stored one or more sets of instructions 518 (e.g., software code) configured to implement one or more of the methodologies, procedures, or functions described herein. The instructions 518 can also reside, completely or at least partially, within the memory 510 and/or within the CPU 506 during execution thereof by the active processing module 308. The memory 510 and the CPU 506 also can constitute machine-readable media.

According to other embodiments of the present invention, the active processing module 308 is a plug-and-play device. In this regard, the software 518, 526, 528, 530 stored locally on the active processing module 308 will automatically be executed at power up of the active processing module 308 by the processing unit 506. Thereafter, the processing unit 506 can send commands and other information to the consumer electronic device (e.g., the camera 100 of FIG. 1) via the I/O interface 502. The processing unit 506 can also receive information from the consumer electronic device via the I/O interface 502. Embodiments of the present invention are not limited in this regard.

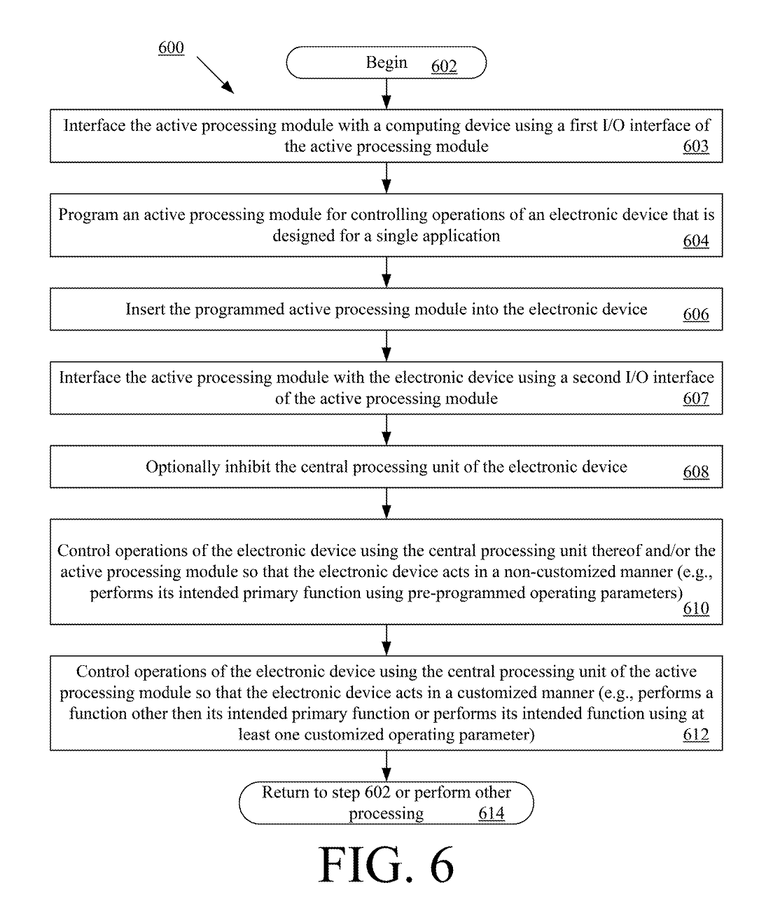

Notably, the camera 100 of FIG. 1 implements a method 600 for controlling operations of a consumer electronic device. The following FIG. 6 and accompanying text illustrate such a method 600 for controlling operations of a consumer electronic device. It should be appreciated, however, that the method 600 disclosed herein is provided for purposes of illustration only and that embodiments of the present invention are not limited solely to the method shown.

Referring now to FIG. 6, there is provided a flow diagram of an exemplary method 600 for controlling operations of a consumer electronic device (e.g., the camera 100 of FIG. 1). As shown in FIG. 6, the method begins with step 602 and continues with step 603. Step 603 involves interfacing the active processing module with a computing device using a first I/O interface (e.g., I/O interface 504 of FIG. 5) of the active processing module. The computing device can include, but is not limited to, a computer workstation, a desktop personal computer system, a laptop personal computer system, or any other general purpose computer processing device.

In a next step 604, the active processing module (e.g., active processing module 308 of FIG. 3) is programmed for controlling operations of a consumer electronic device (e.g., the camera 100 of FIGS. 1-4) that is useful for an intended job (e.g., record images as still photographs, records video, play video games, display pictures, guiding a user to a desired destination). The active processing module can be programmed by a manufacturer and/or consumer of the device using input and output devices of the computing device.

The active processing module can be a plug-and-play card. In this scenario, software (e.g., software 518, 526, 528, 530 of FIG. 5) stored in the active processing module is executed at power-up of the active processing module. Thereafter, a consumer or manufacturer can modify an existing device-control application and/or develop a new device-control application using the software executing on the active processing module. The modified and/or new device-control application can be stored in the active processing module. The consumer or manufacturer can also set operating parameter values for a particular consumer electronic device using the software executing on the active processing module.

After completing step 604, the method 600 continues with step 606. In step 606, the programmed active processing module (e.g., active processing module 308 of FIG. 3) is inserted into a consumer electronic device (e.g., the camera 100 of FIG. 1). In this regard, it should be emphasized that the consumer electronic device has a connector (e.g., connector 302 of FIG. 3) that mates with a respective connector (e.g., edge connector 524 of FIG. 5) of the active processing module.

Subsequent to the insertion of the active processing module into the electronic device, step 607 is performed where the active processing module is interfaced with the electronic device. The device interfacing is achieved using a second I/O interface (e.g., I/O interface 502 of FIG. 5) of the active processing module and a module interface (e.g., the module interface 428 of FIG. 4) of the electronic device.

In an optional next step 608, a central processing unit (e.g., CPU 424 of FIG. 4) is inhibited from controlling one or more operations of the electronic device. The central processing unit can be inhibited from controlling operations of the electronic device in response to the detection of an active processing unit by the electronic device. In this scenario, the electronic device can include a sensor or switch for detecting when an active processing module is fully or partially inserted into the electronic device. The sensor or switch can cause a signal to be communicated to the central processing unit when the active processing module is detected thereby. Alternatively, the central processing unit can be inhibited from controlling operations of the electronic device by the active processing unit.

Optional step 608 is performed when the active processing module is to control all operations of the electronic device. In this scenario, all communications to and from the central processing unit of the electronic device are redirected to the active processing module. However, step 608 may not be performed when the active processing unit is to control device operations in conjunction with the central processing unit of the electronic device. In this scenario, some of the communications to and from the central processing unit of the electronic device may be redirected to the active processing module.

Upon competing step 606 and/or optional step 608, step 610 and/or step 612 are performed. In step 610, operations of the electronic device are controlled so that the electronic device acts in a non-customized manner, i.e., the electronic device performs it intended primary function using pre-programmed operating parameters. The operations of the electronic device can be controlled by the central processing unit thereof and/or the active processing module.

In step 612, the operations of the electronic device are controlled so that the electronic device acts in a customized manner. For example, the electronic device performs a function other than its intended function (e.g., a camera acts as a digital travel guide, a navigation unit, a gaming machine, a digital learning guide, a digital cooking assistant, a digital cooking guide, an electronic book viewer, a digital phone book and/or a personal digital calendar) or performs its intended function using customized operating parameters (e.g., the camera performs imaging operations using a shutter time that is longer than that originally specified by the manufacturer). Upon completing step 612, step 614 is performed where the method 600 returns to step 602 or other processing is performed.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

We claim:

1. A method for controlling an electronic device with an active processing module having a first and second input/output interface, comprising:
interfacing an active processing module and a computing device using said first input/output interface of said active processing module;
programming said active processing module using a user interface of said computing device;
interfacing said active processing module and said electronic device using at least said second input/output interface of said active processing module; and
controlling operations of said electronic device using at least a processing unit of said active processing module.

2. The method according to claim 1, wherein said programming further comprises developing device-control software using application development software executing on said active processing module.

3. The method according to claim 1, wherein said programming further comprises setting a customized value for at least one of a plurality of operating parameters of said electronic device using parameter setting software executing on said active processing module.

4. The method according to claim 1, further comprising inhibiting a processing unit of said electronic device from controlling at least one operation of said electronic device.

5. The method according to claim 4, further comprising redirecting communications directed to said processing unit of said electronic device to said active processing module.

6. The method according to claim 1, wherein said operations of said electronic device are controlled using a custom operating parameter for said electronic device.

7. The method according to claim 1, wherein said operations of said electronic device are controlled using device-control software executing on said active processing module.

8. The method according to claim 1, wherein said operations of said electronic device are controlled so that said electronic device performs at least one secondary function different than a primary function of said electronic device.

9. The method according to claim 8, further comprising selecting said primary function from the group consisting of an imaging function, a navigation function, a gaming function and a picture display function.

10. The method according to claim 8, further comprising selecting said secondary function from the group consisting of a travel guide function, a navigation function, a gaming function, a learning guide function, an assistant function, an electronic book viewer function, a media player function and a wireless connection function.

11. An active processing module, comprising:
a first input/output interface configured for interfacing said active processing module with a computing device so that said active processing module can be programmed by developing device-control software using application development software executing on said active processing module or by setting a custom value for at least one of a plurality of operating parameters of an electronic device using parameter setting software executing on said active processing module;
a second input/output interface configured for interfacing said active processing module with said electronic device; and
at least one processing device configured for controlling operations of said electronic device so that said electronic device performs a primary function using said custom value or performs a secondary function different from said primary function.

12. The active processing module according to claim 11, wherein said processing device is further configured for inhibiting a processing unit of said electronic device from controlling said operations of said electronic device.

13. The active processing module according to claim 11, wherein said primary function is selected from the group consisting of an imaging function, a navigation function, a gaming function and a picture display function.

14. The active processing module according to claim 11, wherein said secondary function is selected from the group consisting of a travel guide function, a navigation function, a gaming function, a learning guide function, an assistant function, an electronic book viewer function, a media player function and a wireless connection function.

15. A system, comprising:
an electronic device configured to perform a primary function; and
an active processing module comprising
a first input/output interface configured for interfacing said active processing module with a computing device so that said active processing module can be programmed,
a second input/output interface configured for interfacing said active processing module with said electronic device, and
at least one processing device configured for controlling operations of said electronic device so that said electronic device performs said primary function using at least one custom operating parameter or performs a secondary function different from said primary function.

16. The system according to claim 15, wherein said active processing module is programmed by developing device-control software using application development software executing on said active processing module or by setting a customized value for at least one of a plurality of operating parameters of said electronic device using parameter setting software executing on said active processing module.

17. The system according to claim 15, wherein said processing device is further configured for inhibiting a processing unit of said electronic device from controlling at least one operation of said electronic device.

18. The system according to claim 15, wherein said operations of said electronic device are controlled using device-control software executing on said active processing module.

19. The system according to claim 15, wherein said primary function is selected from the group consisting of an imaging function, a navigation function, a gaming function and a picture display function.

20. The system according to claim 15, wherein said secondary function is selected from the group consisting of a travel guide function, a navigation function, a gaming function, a learning guide function, an assistant function, an electronic book viewer function, a media player function and a wireless connection function.
